(19) United States
(12) Patent Application Publication
(10) Pub. No.: US 2020/0122278 A1
(43) Pub. Date: Apr. 23, 2020

(54) LEAD FREE SOLDER COMPOSITION WITH HIGH DUCTILITY

(71) Applicant: Hebei Lixin Technology Co., Ltd, Handan (CN)

(72) Inventor: Suixiang HUANG, Handan (CN)

(21) Appl. No.: 16/165,497

(22) Filed: Oct. 19, 2018

(51) Int. Cl. B23K 35/26; C22C 28/00

(52) U.S. Cl. CPC B23K 35/26; C22C 28/00

(57) ABSTRACT

A lead free solder composition is disclosed and includes: 0.02% to 6% by weight stibium, 0.03% to 3% by weight copper, 0.03% to 8% by weight bismuth, 55% to 68% by weight indium, 0.3% to 8% by weight silver, 5% to 11% by weight magnesium, 0.3% to 1.45% by weight scandium, 0.6% to 1.8% by weight cerium, and 10% to 45% by weight tin. The lead free solder composition of the invention has a solidus temperature no lower than 120° C., has good ductility and stability, and hence is suitable for soldering electrical connectors onto the metalized surface on the glass.

### TECHNICAL FIELD

The present invention relates to a lead free solder composition, and particularly to a lead free solder composition with high ductility.

### TECHNICAL BACKGROUND

Rear windows of automobiles typically include electrical devices, such as defrosters, located on the glass. In order to provide electrical connections to the electrical devices, a small area of metallic coating is generally applied to the glass to obtain a metalized surface which is configured to be electrically connected to the electrical device, and then an electrical connector of the electrical device can be soldered onto the metalized surface.

In the prior art, the electrical connector is soldered onto the metalized surface on the glass with a solder containing lead (Pb). However, due to environmental pollution caused by lead, the use of lead is more and more limited, and hence a lead free solder begins to be used in soldering applications. For example, a common lead free solder containing a high tin (Sn) content such as more than 80% is employed in some industries.

However, the glass is brittle, thus the common lead free solder with a high tin content tends to cause cracking of the glass while soldering the electrical device onto the glass. Moreover, soldering two materials (such as glass and cooper) which differ substantially in Coefficient of thermal expansion (CTE) imposes stress on the solder either during cooling of the solder joint or during subsequent temperature excursions. Therefore, on one hand, the solder composition suitable for soldering the electrical device onto the glass needs to have a melting point (i.e. liquidus temperature) that is low enough to not cause cracking of the automotive glass during the soldering process, because a higher melting point and correspondingly higher processing temperature augments the adverse effects of CTE mismatch, imposing higher stress on the solder during cooling. As a result, the solder is further required to have good Ductility. On the other hand, the melting point of the solder composition needs to be high enough, so that the solder will not melt during the normal usage of the automobile, such as when the car is in the sun with the windows closed or under other extreme harsh environmental conditions.

Conventionally already disclosed is a lead free solder composition with a weight percentage of 64.35%-65.65% indium (In), 29.7%-30.3% tin (Sn), 4.05%-4.95% silver (Ag) and 0.25%-0.75% copper (Cu) (hereinafter referred to as the “65 Indium Solder”).

Solders that contain indium, however, normally have much lower melting points than other solders. The 65 Indium Solder, for example, has a solidus temperature of 109° C., compared to 160° C. of the lead solder, and a liquidus temperature of 127° C., compared to 224° C. of the lead solder. Generally, a higher indium content in the solder causes a lower solidus temperature of the solder. Some vehicle manufacturers desire that the solder joint should be capable of surviving elevated temperatures, accordingly the solder with a indium content should have a solidus temperature no lower than 120° C. and have a good ductility at a temperature range from −40° C. to 120° C., without any deterioration in performance.

Further, in soldering a plurality of electrical connectors arranged closely, the soldering of an electrical connector will affect the adjacent soldered electrical connector, and hence the solder must have high stability and ductility, otherwise remelting and cracking of the adjacent electrical connector will likely occur.

### SUMMARY

Accordingly, an object of the invention is to provide a lead free solder composition, including: 0.02% to 6% by weight stibium, 0.03% to 3% by weight copper, 0.03% to 8% by weight bismuth, 55% to 68% by weight indium, 0.3% to 8% by weight silver, 5% to 11% by weight magnesium, 0.3% to 1.45% by weight scandium, 0.6% to 1.8% by weight cerium, and 10% to 45% by weight tin.

Preferably, the lead free solder composition may include 1.0% to 1.1% by weight scandium.

Preferably, the lead free solder composition may include 0.7% to 0.8% by weight cerium.

The lead free solder composition may have a solidus temperature in a range from 120° C. to 135° C.

Further, the solder composition may have a liquidus temperature in a range from 130° C. to 145° C.

Preferably, the lead free solder composition may include 3% to 4% by weight stibium.

Preferably, the lead free solder composition may include 4% to 5% by weight bismuth.

The lead free solder composition of the invention has a solidus temperature no lower than 120° C., has good ductility and stability, and hence is suitable for soldering electrical connectors onto the metalized surface on the glass.

### DETAILED DESCRIPTION OF THE PREFERRED EMBODIMENT

The present disclosure will be further illustrated in detail below in conjunction with some embodiments. It may be understood that specific embodiments described herein are merely for explaining the present disclosure rather than limiting the present disclosure.

The present disclosure provides a lead free solder composition, which is suitable for soldering electrical elements on glass. Illustratively, such soldering is required for manufacturing a rear window of a car, which includes a window defroster consisting of electrically resistive defrosting lines embedded within or deposited on the inner surface of the rear window. The defrosting lines are electrically connected to a pair of electrical contact strips (i.e. electrical contact surfaces, also referred to as buss bars) located on the inner surface of the rear window. The electrical contact strips may consist of a conductive coating deposited on the inner surface of the rear window. Typically, the electrical contact strips are formed from silver-containing material.

To overcome the problem in the prior art, an embodiment of the invention provides a lead free solder composition, including: 0.02% to 6% by weight stibium, 0.03% to 3% by weight copper, 0.03% to 8% by weight bismuth, 55% to 68% by weight indium, 0.3% to 8% by weight silver, 5% to 11% by weight magnesium, 0.3% to 1.45% by weight scandium, 0.6% to 1.8% by weight cerium, and 10% to 45% by weight tin.

In the embodiment, the lead free solder composition includes scandium and cerium, among which scandium has an effect of reducing a grain size and a feature of raising a recrystallization temperature and can enhance the ductility and stability of the solder, while cerium is featured by high melting point, high strength and strong anti-corrosion, can enhance strength, high-temperature resistance and anti-corrosion of the solder, can avoid cracking of the solder joint, and increases the solidus temperature of the solder composition to be within a range from 120° C. to 135° C. and the liquidus temperature of the solder composition to be within a range from 130° C. to 145° C.

In some embodiments, the lead free solder composition may include 1.0% to 1.1% by weight, more preferably 1.05% by weight, scandium.

In some embodiments, the lead free solder composition may include 0.7% to 0.8% by weight, more preferably 0.75% by weight, cerium.

In some embodiments, the lead free solder composition may include 3% to 4% by weight stibium and 4% to 5% by weight bismuth.

In some embodiments, the lead free solder composition may include 6% to 10% by weight, preferably 7% to 9% by weight, more preferably 8% by weight, magnesium. In some other embodiments, the lead free solder composition may include 8% to 9% by weight magnesium.

As mentioned above, the lead free solder composition of the invention has a solidus temperature within a range from 120° C. to 135° C. and a liquidus temperature within a range from 130° C. to 145° C. The solidus temperature is practically defined as the temperature at which an alloy begins to melt. Below the solidus temperature, the substance is completely solid, without molten phase. The liquidus temperature is the maximum temperature at which crystals (unmolten metal or alloy) can co-exist with the melt. Above the liquidus temperature, the material is homogeneous, consisting of melt only. The solder processing temperature is higher than the liquidus temperature, by a number of degrees that is determined by the soldering technique.

The solder composition of the invention is free of lead, and has a working temperature higher than that of other solder of the same type which is typically about 105° C. Also, solder composition of the invention has much better ductility and stability, compared with the existing lead free solder composition in the prior art.

The combination of bismuth and copper with other elements improves the overall performance of the solder composition, including an expected increase of the working temperature of the solder and an enhancement of the mechanical performance of the solder under specific conditions.

In some embodiments, the lead free solder composition may have a solidus temperature in a range from 120° C. to 135° C.

Further in some embodiments, the solder composition may have a liquidus temperature in a range from 130° C. to 145° C.

In some embodiments, the lead free solder composition may include 3% to 4% by weight stibium.

In some embodiments, the lead free solder composition may include 4% to 5% by weight bismuth.

The lead free solder composition of the invention has a solidus temperature no lower than 120° C., has good ductility and stability, and hence is suitable for soldering electrical connectors onto the metalized surface on the glass.

Now the anti-cracking performance of the solder joint formed by the lead free solder composition of the invention will be described below with comparison between the embodiments of the invention and some comparative examples, as shown in Table 1 below.

TABLE 1

| | | Embodi- | Embodi- | Embodi- | Embodi- | Embodi- | Comp. | Comp. |
|---|---|---|---|---|---|---|---|---|
| | | ment | ment | ment | ment | ment | Example | Example |
| | | 1 | 2 | 3 | 4 | 5 | 1 | 2 |
| Content | stibium | 1 | 2.3 | 4 | 4.3 | 5 | 4 | 5 |
| (% by | copper | 0.1 | 0.5 | 1 | 1.4 | 2 | 1 | 2 |
| weight) | bismuth | 0.5 | 1.5 | 3 | 5 | 7 | 3 | 5 |
| | indium | 55 | 57 | 60 | 65 | 68 | 57 | 60 |
| | silver | 0.5 | 1.5 | 2.5 | 4 | 6 | 2.5 | 4 |
| | magnesium | 5 | 7 | 8 | 9 | 10 | 8 | 9 |
| | scandium | 0.3 | 0.6 | 1.1 | 1.2 | 1.45 | 0.2 | 1.8 |
| | cerium | 0.6 | 0.6 | 1.0 | 1.2 | 1.8 | 0.05 | 2.0 |
| | tin | 10 | 20 | 25 | 30 | 40 | 30 | 40 |

| | | | | | | | |
|---|---|---|---|---|---|---|---|
| Cracking | √ | √ | √ | √ | √ | x | x |
| Ductility | Good | Good | Good | Good | Good | Poor | Poor |

Note:
V: cracking does NOT occur to adjacent solder joints during soldering
X: cracking occurs to adjacent solder joints during soldering

As can be seen from the above table, when scandium is contained at an amount in a range from 0.3% to 1.45% by weight in the solder composition, the cracking of the solder joint formed by the lead free solder composition of the invention can be avoided in the subsequent processes. However, when scandium is contained at an amount less than 0.3% by weight or larger than 1.45% by weight in the solder composition, the anti-cracking performance of the solder is degraded. Additionally, when cerium is contained at an amount in a range from 0.6% to 1.8% by weight in the solder composition, the solder joint formed by the lead free solder composition of the invention has good ductility. However, when cerium is contained at an amount less than 0.6% by weight or larger than 1.8% by weight in the solder composition, the ductility performance of the solder is degraded.

High Temperature Storage Test

The ductility performance of the lead free solder of the embodiments of the invention is tested by a high temperature storage test. In this test, the temperature of a climate controlled chamber was maintained at a constant 120° C., an electrical connector and a metalized surface on which the electrical connector was soldered by the solder of the invention were placed in the climate controlled chamber, and a weight of 6 Newtons was hung from the electrical connector for 24 hours. After the end of the 24 hours, the electrical connector was pulled (at ambient temperature) with a force of 50 N by a digital force gauge for 3 seconds, and no disconnection of cracking from the electrical connector occurred during this test.

It is noted that the preferable embodiments and the applied technology principles of the present disclosure are merely described as above. It should be understood for those skilled in the art that the present disclosure is not limited to particular embodiments described herein. Various apparent changes, readjustment and alternative can be made by those skilled in the art without departing the scope of protection of the present disclosure. Therefore, although the present disclosure is illustrated in detail through the above embodiments, the present disclosure is not merely limited to the above embodiments, and can further include more of other equivalent embodiments without departing the conception of the present disclosure. The scope of the present disclosure is subject to the appended claims.

1. A lead free solder composition, comprising:
0.02% to 6% by weight stibium,
0.03% to 3% by weight copper,
0.03% to 8% by weight bismuth,
55% to 68% by weight indium,
0.3% to 8% by weight silver,
5% to 11% by weight magnesium,
0.3% to 1.45% by weight scandium,
0.6% to 1.8% by weight cerium, and
10% to 45% by weight tin.

2. The lead free solder composition of claim 1, comprising 1.0% to 1.1% by weight scandium.

3. The lead free solder composition of claim 1, comprising 0.7% to 0.8% by weight cerium.

4. The lead free solder composition of claim 1, wherein the lead free solder composition has a solidus temperature in a range from 120° C. to 135° C.

5. The lead free solder composition of claim 3, wherein the lead free solder composition has a liquidus temperature in a range from 130° C. to 145° C.
